(19) United States
(12) Patent Application Publication
(10) Pub. No.: US 2009/0097807 A1
(43) Pub. Date: Apr. 16, 2009

(54) Shaping a laser beam with a fiber-based device

(76) Inventors: Xijia Gu, Toronto (CA); Waleed Soliman Mohammed Soliman, Bangkok (TH)

Correspondence Address: Mirek A. Waraksa, 1707-145 Marlee Ave., Toronto, ON, M6B 3H3, CA

(21) Appl. No.: 11/907,650

(22) Filed: Oct. 16, 2007

(51) Int. Cl. G02B 6/02

(52) U.S. Cl. 385/123

(57) ABSTRACT

A fiber-based device and associated method effectively convert a laser beam with an initial intensity distribution of Gaussian shape into a beam with another intensity distribution, which might typically be uniform or ring-shaped although other configurations are possible. The device comprises a single mode fiber with a core in which the beam is guided and a cladding surrounding the core. A component inline with the fiber couples a portion of the guided beam from the core into the cladding for propagation through the cladding toward an output end of the fiber. Interaction between core and cladding propagation modes produces the other intensity distribution at a predetermined distance from the output end of the fiber.

### FIELD OF THE INVENTION

The invention relates generally to shaping of laser beams, and more specifically, to conversion of a laser beam with a Gaussian intensity distribution effectively into a beam with another intensity distribution. Substantially uniform and ring-shaped intensity distributions are of primary interest but other distributions can be achieved with the invention.

### DESCRIPTION OF THE PRIOR ART

The Gaussian-shaped laser beam typically produced by a laser is satisfactory for applications that involve cutting or marking. However, other applications such as laser lithography or medical treatment require a beam with a substantially uniform intensity profile often referred to as a “top-hat” profile. It is known to use diffractive optical components to bend a Gaussian-shaped distribution of rays to approximate a beam of uniform intensity [1]. (References to technical publications are identified with numbers in square brackets and are detailed below after the description of preferred embodiments.) Another approach is to use a laser beam homogenizer that breaks a Gaussian input beam into many beamlets using a lens array and then uses a lens to superimpose them on an output plane [2]. A major shortcoming of both approaches is the need to use bulk optical components that require precise fabrication and alignment. Moreover, reflection at operative surfaces of the optical components can be expected to introduce power losses unless anti-reflective coatings adapted to accommodate high laser power are used.

With rapid progress in high-power fiber laser technology, it would be desirable to provide a fiber-based solution for transforming a Gaussian intensity profile into a top-hat profile. In that regard, it is noted that Matsuura et al. [3]reported use of a 0.7 mm diameter silver-halide fiber tip attached to a hollow waveguide to homogenize a CO₂ laser beam and reduce waveguide bending losses. Beam uniformity was not, however, detailed. Hayes et al. [4] recently reported a square core jacketed air-clad fiber designed to deliver Q-switched Nd:YAG radiation from highly multimode sources. A top-hat intensity profile was achieved at the near-field of its approximately 400 μm square core but far-field beam homogeneity was not reported. A shortcoming associated with such approaches is that specialty fibers or fiber tips are required. Additionally, these approaches are incompatible with use of single mode fibers, and do not lend themselves to production of other useful intensity distributions, such as ring-shaped distributions.

### SUMMARY OF THE INVENTION

In one aspect, the invention provides a method of applying a laser beam to an object in which the laser beam has an initial intensity distribution of Gaussian shape and a final intensity distribution of predetermined shape at a surface of the object. The method involves guiding the laser beam along a single mode fiber from an input end of the fiber toward an output end of the fiber, the fiber comprising a core in which the laser beam is guided and a cladding that surrounds the core. A portion of the guided beam is coupled from the core into the cladding for propagation along the cladding toward the output end of the fiber. This is preferably achieved with a long-period grating (“LPG”) installed inline with the fiber, which may typically be adapted to couple the single transmission mode of the core to a lower order cladding mode. The surface of the object is placed at a position spaced from the output end of the fiber where interaction between core and cladding propagation modes produces the final intensity distribution. Although a single LPG can be used for such purposes, multiple components may be used to couple the single mode of the core to varying degrees into different cladding modes, allowing greater freedom in shaping the laser beam. As will be demonstrated below, it is possible to produce useful approximations of a uniform intensity distribution, a ring-shaped distribution and others.

In another aspect, the invention provides a device for shaping a laser beam that has an intensity distribution of Gaussian shape. The device comprises a single mode fiber with an input end for receiving the laser beam, an output end for discharging the beam from the fiber, a core in which the received laser beam is guided from the input end toward the output end, and a cladding that surrounds the core. The device further comprises means inline with the fiber for imparting a predetermined intensity distribution to the discharged beam at a predetermined distance from the output end of the fiber. Such means couple a portion of the guided beam from the core into the cladding for propagation through the cladding toward the output end of the fiber such that interaction between core and cladding propagation modes produces the predetermined intensity distribution.

The invention relies on interaction between core and cladding propagation modes to effectively shape a laser beam. In that regard, it is well-known that an LPG can couple light from the guided core mode into forward-propagating cladding modes if the phase matching condition, expressed by equation (1) below, is satisfied [5]:

β₀₁−β₀ₘ=2π/Λ (1)

where, β₀₁ and β₀ₘ are the propagation constants of the core mode LP₀₁ and the m-radial cladding mode LP₀ₘ respectively, and A is the LPG period. If the LPG is formed perpendicular to the fiber axis, only radially symmetric cladding modes are excited. As regards low-order radial modes, the effective mode indices are sufficiently different that the phase matching condition constrains the core mode to be coupled to only one selected LP₀ₘ mode. This coupling can be made very efficient, and a conversion efficiency of over 99% at the resonant wavelength can be easily achieved using an LPG 2 to 4 cm long [5]. In practice, an insertion loss of only 0.1 dB was necessitated.

Coupling the core mode LP₀₁ into a low-order cladding mode LP₀ₘ effectively enlarges the beam size since a Gaussian distribution is converted into a series of larger concentric rings with m nodes. The lower-order LP₀ₘ modes can propagate a long distance with negligible modal distortion or coupling into higher order LP₁ₘ modes, as has been demonstrated [6]. If only part of the core mode is coupled into a cladding mode, the two modes will interfere. Because of their different propagation constants, the interference pattern will vary as the modes propagate along the fiber and through free space at the end of the fiber. Since destructive interference can lead to reduced field intensity at the centre of the beam and enhanced field intensity in the first or second ring of the cladding mode, it is possible to achieve an approximation to a beam of uniform intensity.

The complex amplitudes of the core and cladding modes at the end of the LPG can be calculated using coupled mode analysis [7]. The total field at the end of the fiber is then

E(r)=Aψ₀₁(r)+Bψ₀ₘ(r)Exp[iΔφₘ] (2)

where

Δφₘ=Δφₘ+(β₀ₘ−β₀₁)L_{f} (3)

A² and B² are the relative powers in the core and cladding modes, respectively, and are related by the equation A²+B²=1. ψ₀₁ and ψ₀ₘ are the mode amplitudes for the core and the cladding modes, respectively. L_{f} is the distance from the end of the LPG to the end of the fiber, and L_{f} and other geometric parameters may be better understood with reference to FIG. 1. Δφₘ is the phase difference between the two modes at the end of the LPG calculated according to coupled mode analysis. This phase difference depends mainly on the grating parameters and β₀₁ and β₀ₘ. The propagation inside the remaining part of the fiber causes only an extra phase shift, as shown in equation (3). The field distribution at an observation plane spaced a distance D from the output end of the fiber is calculated using the expression for Fresnel propagation in cylindrical coordinates:

$${E}_{D} ( r ) = \frac{2 π}{i λ D} {e}^{i \frac{ π {r}^{2}}{λ D}} {\int }_{ρ = 0}^{R} E ( ρ ) {e}^{i \frac{π {ρ}^{2}}{λ D}} {J}_{0} ( \frac{2 π ρ r}{λ D} ) ρ d ρ \qquad ( 4 )$$

where, ρ is the radius of the field amplitude at the output end of the fiber, and R is the outer cladding radius. Equations (2) through (4) demonstrate that there are several factors affecting laser beam shaping using an LPG: the field distribution of the cladding mode, the amount of light coupled from the core to the cladding, the phase difference between the core and cladding, and the distance from the fiber end to the observation plane or the surface of an object to be irradiated.

Various aspects of the invention will be apparent from the foregoing summary of the invention and from a description below of preferred embodiments, and will be more specifically defined in the appended claims.

### DESCRIPTION OF THE DRAWINGS

The invention will be better understood with reference to drawings in which:

FIG. 1 schematically illustrates an experimental device for implementing the invention;

FIG. 2 is the transmission spectrum of an LPG comprised by the device;

FIG. 3 (a) is a plot of field intensity relative to x and y axes at a distance of 7 mm from the output end of the device; and,

FIG. 3 (b) is a plot of field intensity comparable to that of FIG. 3 with the LPG in effect removed from the device by appropriate tuning of the wavelength of the source laser beam;

FIG. 4 is a graph showing simulated intensity profiles of the laser beam discharged from the device at discrete distances from the output end of the device;

FIG. 5 is a graph showing qualitatively the intensity profile of the laser beam at a distance of 6 mm from the output end of the fiber;

FIG. 6 is a graph showing how the discharged laser beam diverges as a function of distance from the output end of the device; and,

FIG. 7 is a graph showing the intensity profile of another device embodying the invention.

### DESCRIPTION OF PREFERRED EMBODIMENTS

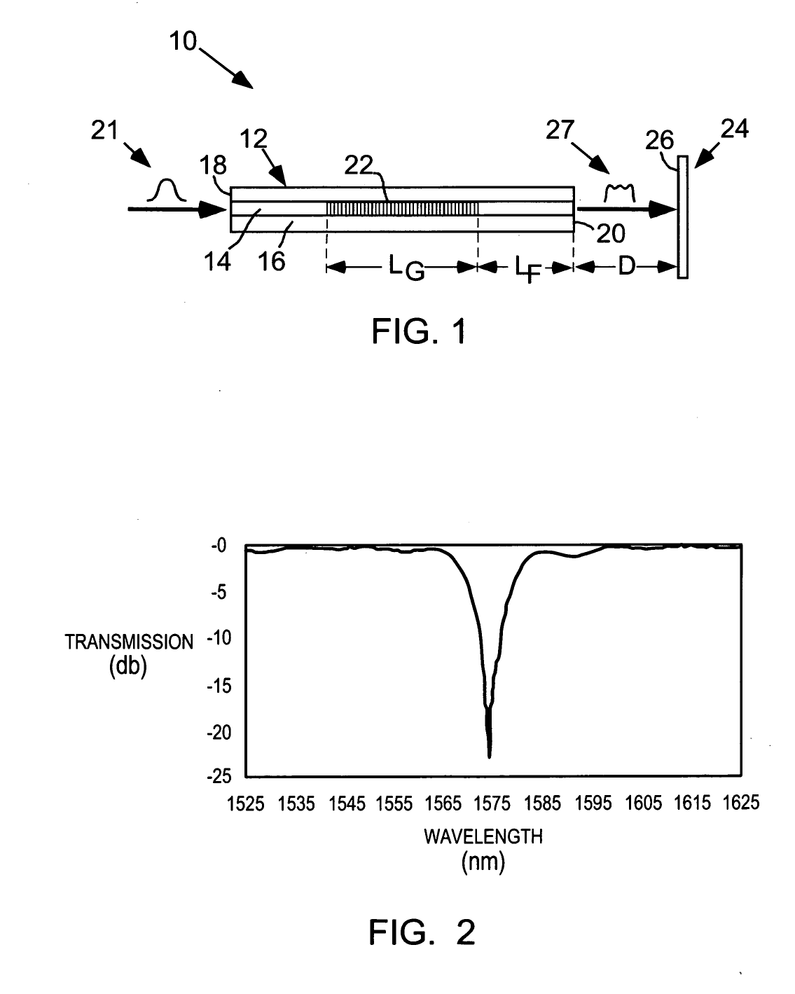

Reference is made to FIG. 1, which schematically illustrates a prototype fiber-based device 10 that effectively converts a Gaussian shaped beam into a beam of substantially uniform intensity. The device 10 comprises a single mode fiber 12 with a core 14, a cladding 16 surrounding the core 14, an input end 18, and an output end 20. The input end 18 receives a laser beam from a tunable laser (not shown) operating in the near infrared range, which beam has a typical Gaussian intensity profile 21. The laser beam is guided within the core 14 toward the output end 20 of the fiber 12. The device 10 also comprises an LPG 22 inscribed inline with the core 14 of the fiber 12 upstream of the output end 20 of the fiber 12, which LPG 22 couples a portion of the light guided in the core 14 into the cladding 16 for forward propagation toward the output end 20. In this embodiment, the core mode is coupled to the LP₀₃ cladding mode. The LPG 22 has a length designated L_{G} and is spaced a distance designated L_{f} upstream from the output end 20 of the fiber 12. An object 24 to be irradiated is positioned with a surface 26 of the object 24 at a distance D from the output end 20 of the fiber 12. As explained more fully below, the distance D is selected such that the beam has a substantially uniform intensity profile 27 at the surface 26 of the object 24.

The LPG 22 was formed in a hydrogen-loaded Corning™ SMF28 fiber by irradiating the core with 248 nm KrF excimer laser light though an amplitude mask, which induces a periodic refractive index modulation along the fiber axis. The length L_{G} of the LPG 22 is approximately 40 mm, and the distance L_{f} from the end of the LPG 22 to the output end 20 of the fiber is approximately 8 mm. It has a period of 620 μm, which ensures phase matching between the fundamental core mode and the LP₀₃ cladding mode within the tuning range of the laser. The transmission spectrum of the LPG 22, shown in FIG. 2, is centered about a wavelength of 1574 nm. It displays a peak coupling efficiency of 99.5% and a full-width-at-half-maximum bandwidth of 10.8 nm. Since the bandwidth of the LPG 22 is much broader than that of the relatively narrow-band output of the tunable laser, the amount of light coupled to the selected cladding mode can be controlled by tuning the laser wavelength across the loss peak of the LPG 22 or even its side lobes.

Laser beam intensity profiles for the device 10 were measured using a laser beam profiler (Photon Inc. Model Beam Scan 1180) for line scanning with a 1 μm slit and by an infrared camera with a spatial resolution of 20 μm in a horizontal direction and 18 μm in a vertical direction (Hamamatsu Electronics, Model C2741) for 2D measurements.

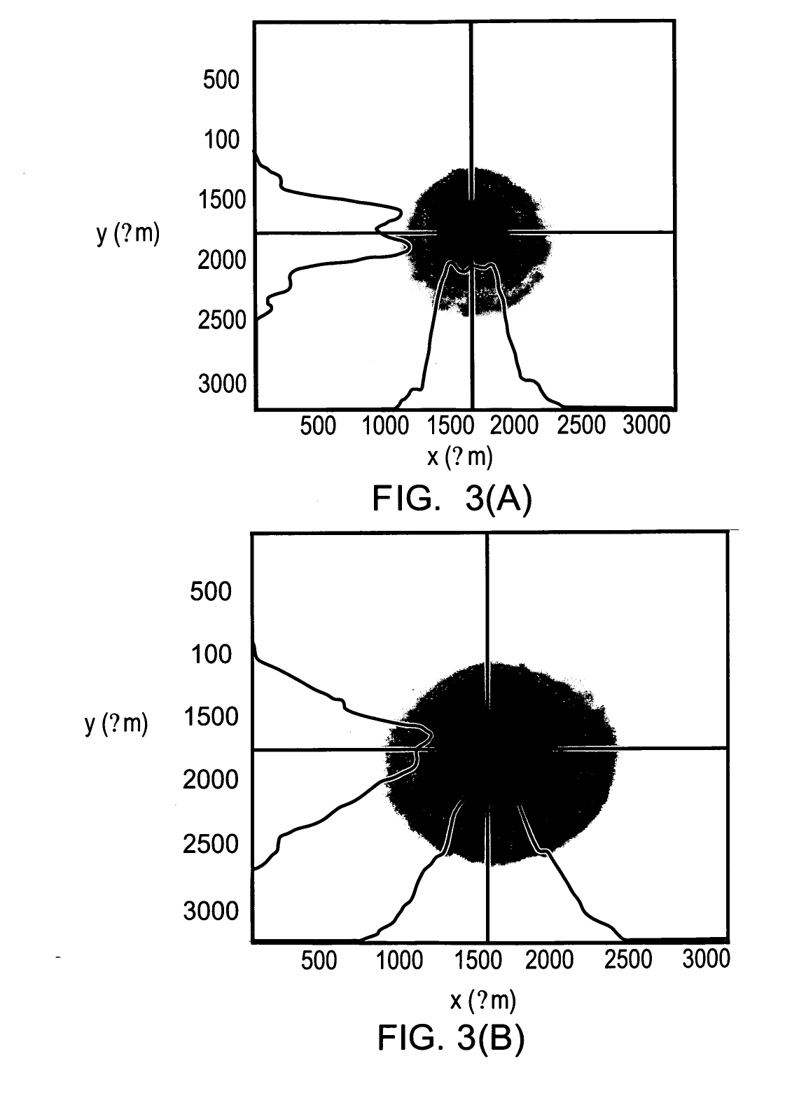

FIG. 3a displays a 2D beam profile measured at a wavelength of 1584.7 nm, which corresponds to about a 10% coupling of light from the core mode to the LP₀₃ cladding mode. Along the x-axis, the intensity variation is less than 5% of the average intensity within a diameter of about 400 μm. Two local maximum intensity spots were observed in the top and bottom of the second ring in FIG. 3(a) but may not be apparent from the drawings attached to this specification. These appear attributable to coupling of a small amount of light into the higher order LP₁₁ mode, and it is believed that the fringes of the LPG 22 may not have been oriented completely perpendicular to the fiber axis during fabrication. Nevertheless, the intensity variation along the y-axis is still less than about 10% of its average intensity within a diameter of about 400 μm. In contrast, FIG. 3(b) displays the Gaussian distribution characteristic of the source laser. This was obtained by setting the wavelength of the source laser to a value distant from the transmission peak at 1574 nm where no significant amount of light is coupled from the core mode to any cladding mode. FIGS. 3(a) and 3(b) clearly demonstrate the beam homogenizing effect of the device 10.

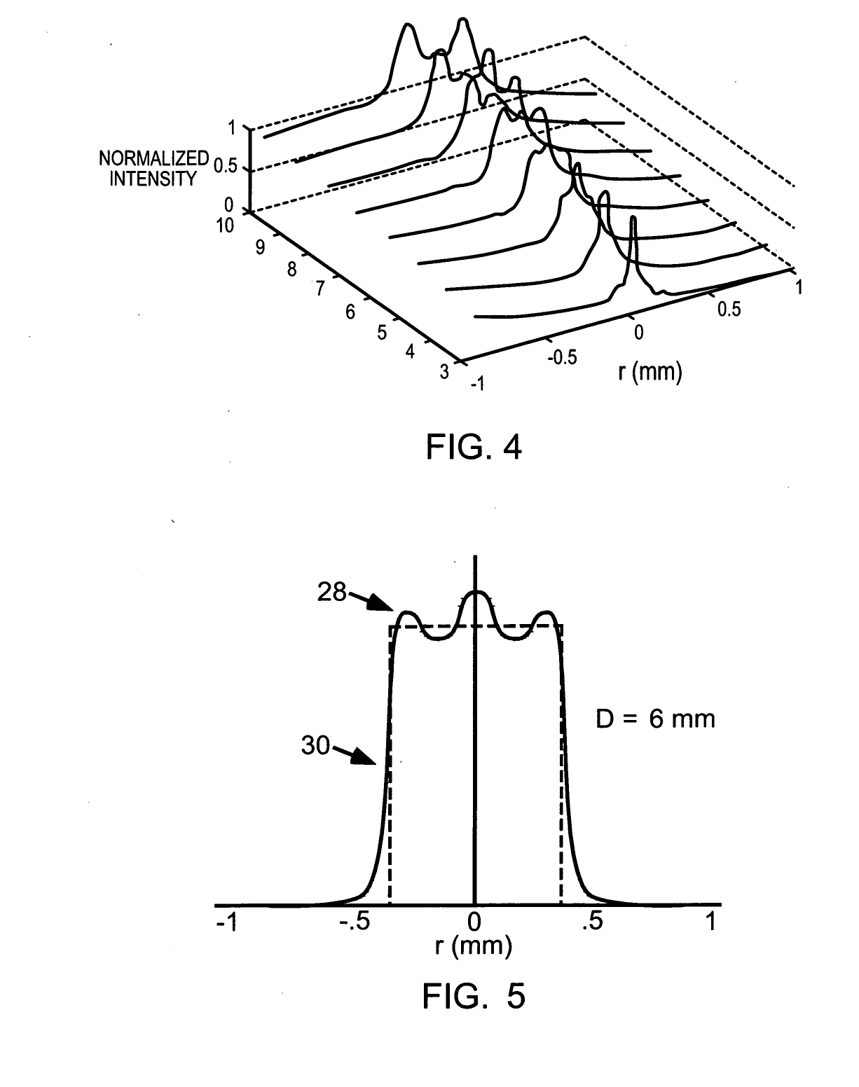

The significance of spacing the object 24 at a distance D from the output end 20 of the fiber 12 will be more apparent from FIG. 4, the results of a simulation producing intensity profiles as a function of distance D, which varies from 3 mm to 10 mm. The simulation considered 10% power coupled from the core mode to the LP₀₃ mode at a wavelength of 1585 nm in the near infrared region of the spectrum. The phase difference Δφₘ was fixed with cladding mode leading core mode by 1.87π. As the beam propagates away from the output end 20 of the fiber 12, the beam profile shows an increasing dip in the center since the core mode diverges faster than the cladding mode. Any such profile can be adopted as the final intensity distribution of the beam at the surface 26 of the object 24 by appropriate selection of the distance D. In this embodiment, destructive interference at the center results in a substantially uniform intensity profile at about 7 mm from the output end 20 of the fiber 12, which can be used to set a working distance for practical applications requiring a substantially uniform intensity distribution.

FIG. 5 shows the profile of the beam at a distance of 6 mm from the output end 20 of the fiber 12. The drawing is not to scale but shows qualitatively the general shape of the simulated profile and, for comparison, the shape of a corresponding ideal uniform intensity profile, shown in phantom outline. The simulated profile has a large central region 28 in which the intensity at any given point varies by no more than 10% from the average intensity value in that region, and a peripheral region 30 in which the intensity drops rapidly toward zero. The net result is a reasonable approximation of a uniform intensity beam.

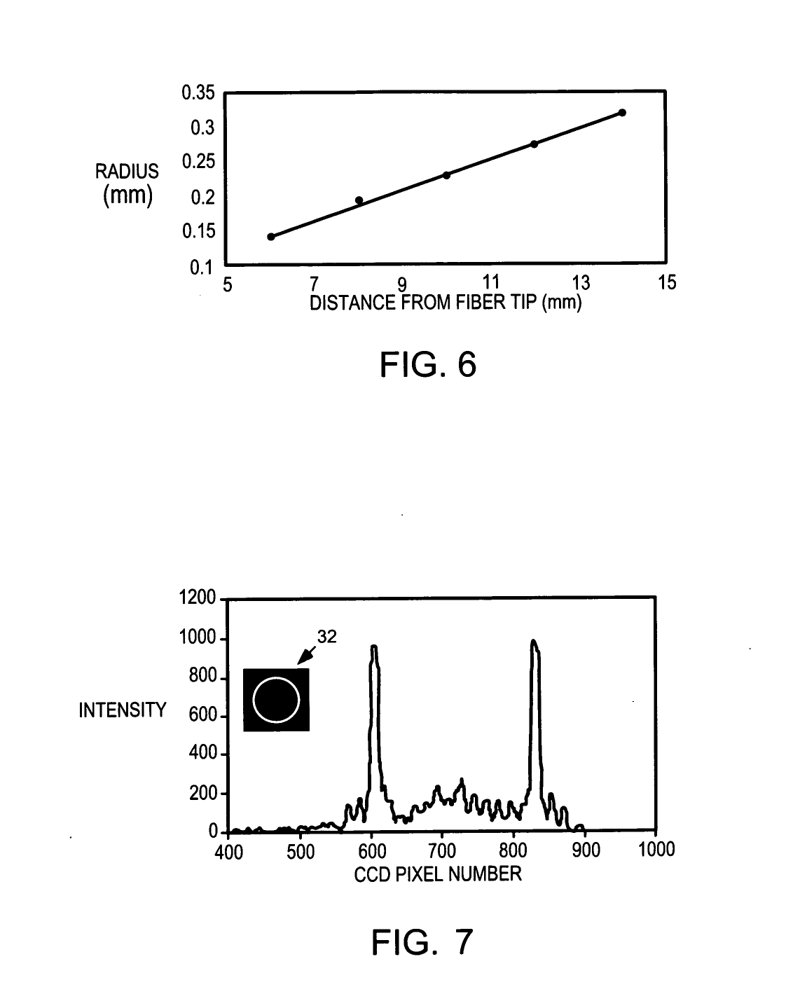

The divergence of the beam output by the device 10 is shown in FIG. 6. The divergence was determined using the beam width at 50% of its maximum intensity, measured by a beam profiler at a distance varying from 6 mm to 14 mm from the end of the fiber 12. Least-square fitting of the data gives a half divergence angle of 1.27°, which is a significant reduction from the 8° divergence angle characteristic of the core mode.

Unlike certain beam shaping devices identified above, the fiber-based device 10 has no interface involving bulk optical components and no need for alignment of such components, and negligible losses are consequently expected. Experimentally, an insertion loss of only about 0.1 dB was measured. Although this embodiment was made for operation in the near infrared range, the principles demonstrated here would also apply to laser beam shaping at other wavelengths.

Another embodiment of the invention, an experimental prototype with the same basic configuration and physical parameters shown in FIG. 1, will be described. An LPG with a loss peak at 660 nm and a period of 480 μm was fabricated using a single mode fiber SMF630A from Prime Optic Fiber Corp. and irradiating the core of the fiber through an appropriate mask with 248 nm light. The length L_{G} of the LPG was 33 mm, and the distance L_{f} between the LPG and the end of the fiber was set to 6 mm. A Gaussian laser beam of wavelength 660 nm in the visible spectrum was applied to the input end of the fiber, and FIG. 7 is a corresponding plot of field intensity at a distance D of 10.5 mm from the output end of the device, derived from a charge coupled device (“CCD”) camera. The intensity values on the vertical axis of the graph are in arbitrary units, and the values on the horizontal axis are in pixels. The radial profile presented in FIG. 7 corresponds substantially to a ring-shape, the ring-shape being more evident in the insert 32 in FIG. 7, a two dimensional image taken with the CCD camera.

It will be appreciated that particular embodiments of the invention have been described and that modifications may be made therein without necessarily departing from the scope of the appended claims.

### REFERENCES

[1] J. A. Hoffnagle and C. M. Jefferson, “Design and performance of a refractive optical system that converts a Gaussian to a flattop beam,” Appl. Opt. 39, pp 5488-5499, 2000.
[2] D. M. Brown, F. M. Dickey and L. W. Weichman, “Multi-aperture beam integration systems”, p 273 in “Laser Beam Shaping”, by F. M. Dickey and S. C. Holswade, Marcel Dekker, New York, 2000.
[3] Y. Matsuura, M. Miyagi, A. German, L. Nagli and A. Katzir, “Silver-halide fiber tip as a beam homogenizer for infrared hollow waveguides”, Optics Letters, Vol. 22, No. 17, pp 1308-1310, September 1997.
[4] J. R. Hayes, J. C. Flanagan, T. M. Monro, D. J. Richardson, P. Grunewald and R. Allott, “Square core jacketed air-clad fibre”, Optics Express, Vol. 14, No. 22, pp 10345-10350, October 2006.
[5] A. M. Vengsarkar, P. J. Lemaire, J. B. Judkins, V. Bhatia, J. E. Sipe and T. E. Ergodan, “Long-period fibre gratings as band-rejection filters”, Journal of Lightwave Technology, Vol. 14, p 58, 1996.
[6] S. Ramachandran, J. W. Nicholson, S. Ghalmi, M. F. Yan, P. Wisk, E. Monberg, and F. V. Dimarcello, “Light propagation with ultralarge modal areas in optical fibres”, Optics Letters, Vol. 31, No. 12, pp 1797-1799, June, 2006.
[7] H. Stoll, A. Yariv, “Coupled modes analysis of dielectric waveguides,” Optics Communications, Vol. 8, No. 1, pp 5-8, 1973.

We claim:

1. A device for shaping a laser beam that has an intensity distribution of Gaussian shape, comprising:
a single mode fiber comprising an input end for receiving the laser beam, an output end for discharging the beam from the fiber, a core in which the received laser beam is guided from the input end toward the output end, and a cladding that surrounds the core; and,
means inline with the fiber for imparting a predetermined intensity distribution to the discharged beam at a predetermined distance from the output end of the fiber, said means coupling a portion of the guided beam from the core into the cladding for propagation through the cladding toward the output end of the fiber such that interaction between core and cladding propagation modes produces the predetermined intensity distribution.

2. The device of claim 1 in which the predetermined intensity distribution is substantially ring-shaped.

3. The device of claim 1 in which the predetermined intensity distribution is substantially uniform.

4. The device of claim 3 in which the predetermined intensity distribution comprises a central region in which the intensity at any given point varies by no more than about 10% of the average intensity within the central region and a peripheral region surrounding the central region in which the intensity drops rapidly toward zero.

5. The device of claim 1 in which the means inline with the fiber comprise a long-period grating inscribed in the core of the fiber.

6. The device of claim 5 in which the predetermined intensity distribution is substantially uniform.

7. The device of claim 5 in which the predetermined intensity distribution is substantially ring-shaped.

8. A method of applying a laser beam to an object in which the laser beam has an initial intensity distribution of Gaussian shape and a final intensity distribution of predetermined shape at a surface of the object, the method comprising:
guiding the laser beam with its initial intensity distribution along a single mode fiber from an input end of the fiber toward an output end of the fiber, the fiber comprising a core in which the laser beam is guided and a cladding that surrounds the core;
coupling a portion of the guided beam from the core into the cladding for propagation through the cladding toward the output end of the fiber; and,
placing the surface of the object at a position spaced from the output end of the fiber where interaction between core and cladding propagation modes produces the final intensity distribution.

9. The method of claim 8 in which the coupling comprises passing the beam through a long-period grating.

10. The method of claim 8 in which the final intensity distribution is substantially ring-shaped.

11. The method of claim 8 in which the final intensity distribution is substantially uniform.

12. The method of claim 11 in which the predetermined intensity distribution comprises a central region in which the intensity at any given point varies by no more than about 10% of the average intensity within the central region and a peripheral region surrounding the central region in which the intensity drops rapidly toward zero.
